(19) United States
(12) Patent Application Publication
(10) Pub. No.: US 2017/0072517 A1
(43) Pub. Date: Mar. 16, 2017

(54) METHOD FOR REMANUFACTURING MACHINE COMPONENT

(71) Applicant: Caterpillar Inc., Peoria, IL (US)

(72) Inventors: Robert Louis Brockman, Michie, TN (US); Rene Paul Jeanfreau, Corinth, MS (US)

(73) Assignee: Caterpillar Inc., Peoria, IL (US)

(21) Appl. No.: 15/343,639

(22) Filed: Nov. 4, 2016

(51) Int. Cl. B23P 6/02; F02F 1/24

(52) U.S. Cl. CPC B23P 6/02; F02F 1/24; F02F 2200/00

(57) ABSTRACT

A method of remanufacturing a surface of a machine component is provided. The method includes attaching the machine component to a support fixture. The method also includes moving a surface evaluating device relative to the surface of the machine component. The method further includes generating a set of data points using the surface evaluating device. The method includes communicating the set of data points generated by the surface evaluating device to a control module. The method also includes determining a depth of wear on the surface, based on the set of data points received by the control module. The method further includes determining an amount of material to be removed from the surface, based on the depth of wear. The method includes performing a machining operation on the surface for removing the determined amount of material.

### TECHNICAL FIELD

The present disclosure generally relates to a method for remanufacturing a machine component.

### BACKGROUND

Machines, such as those used in construction industries, include an engine to power various components of the machine. The engine is subjected to a variety of loads or stresses during operation of the machine. More specifically, the engine includes a cylinder head that experiences load or stresses from combustion events occurring within combustion chambers of the engine. These loads or stresses causes wear, which in turn causes erosions, surface imperfections, or abrasions on one or more surfaces of the cylinder head. Additionally, after certain amount of time in service, the wear on the cylinder head causes the engine to operate ineffectively.

The surfaces of the cylinder head are repaired or remanufactured using one or more machining processes to remove the erosions, abrasions, or surface imperfections, Typically, an iterative process is followed for remanufacturing of the cylinder head. In such a process, after detecting defects on the surfaces of the cylinder head, a machining process is performed to remove the defects and then the surface is evaluated visually by an operator. If the defects are still present, the cylinder head is further machined. However, this iterative process of machining and evaluating the surfaces has to be performed multiple times until the defects are removed, thereby increasing downtime associated with the engine of the machine, which is undesirable.

### SUMMARY OF THE DISCLOSURE

In one aspect of the present disclosure, a method of remanufacturing a surface of a machine component is provided. The method includes attaching the machine component to a support fixture. The method also includes moving a surface evaluating device relative to the surface of the machine component. The method further includes generating a set of data points using the surface evaluating device. The set of data points are indicative of dimensional characteristics of the surface of the machine component. The method includes communicating the set of data points generated by the surface evaluating device to a control module. The method also includes determining a depth of wear on the surface, based on the set of data points received by the control module. The method further includes determining an amount of material to be removed from the surface, based on the depth of wear. The method includes performing a machining operation on the surface for removing the determined amount of material.

Other features and aspects of this disclosure will be apparent from the following description and the accompanying drawings.

### BRIEF DESCRIPTION OF THE DRAWINGS

FIG. 1 is a perspective view of an exemplary machine component supported on a support fixture, according to various concepts of the present disclosure;

FIG. 2 is a block diagram of a system for remanufacturing a surface of a machine component, according to various concepts of the present disclosure;

FIG. 3 is a side view of a surface evaluating device operating relative to the machine component, according to various concepts of the present disclosure; and

FIG. 4 is a flow chart for a method of remanufacturing the machine component, according to various concepts of the present disclosure;

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

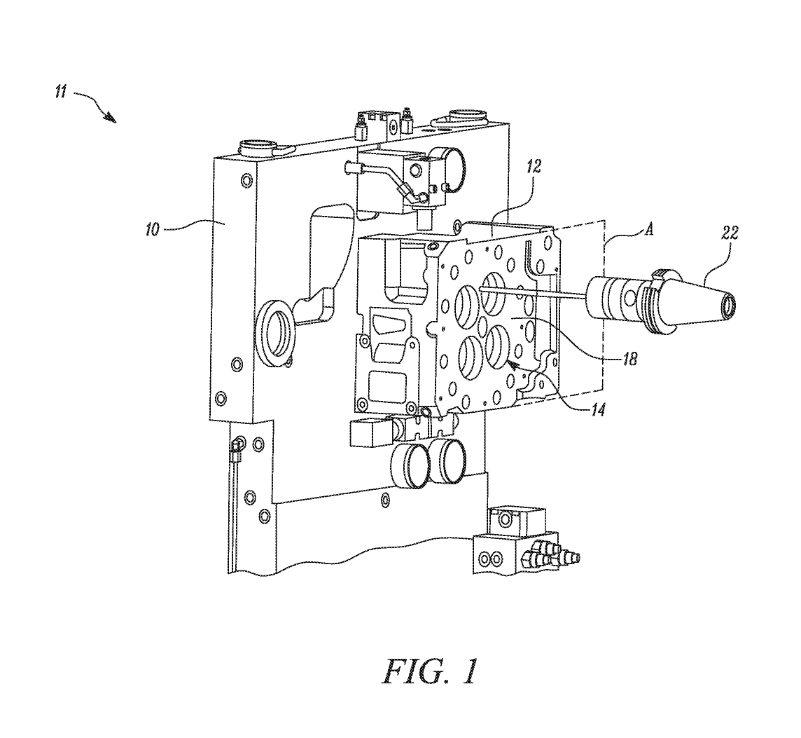

Referring to FIG. 1, an exemplary support fixture 10 is depicted. The support fixture 10 is associated with a Computer Numerical Control (CNC) machine 11. The support fixture 10 holds a machine component 12 in position on the CNC machine 11. The machine component 12 is embodied as a cylinder head. The machine component 12 includes a number of apertures 14. The machine component 12 is associated with an engine (not shown). The engine may embody a compression or spark ignition engine. Further, the engine is mounted on the machine that may be a stationary machine or a mobile machine associated with an industry such as, mining, construction, farming, transportation, or any other industry known in the art.

The engine including the machine component 12 experiences loads and stresses due to combustion events occurring within a number of combustion chambers (not shown) of the engine. More particularly, the machine component 12 experience loads and stresses due to vibrations, high temperatures and the like. Such loads and stresses result in erosions, surface imperfections, or abrasions on a surface 18 of the machine component 12. In the illustrated example, the surface 18 is embodied as a fire deck surface of the cylinder head. Alternatively, the surface 18 may embody other surfaces of the cylinder head including, but not limited to lateral surfaces, surfaces of one of the apertures 14 etc., without limiting the scope of the disclosure.

The present disclosure relates to a system 20 that is employed to remanufacture the surface 18 of the machine component 12. The system 20 used to remanufacture the surface 18 by determining wear of the surface 18 of the machine component 12 will now be described in detail with reference to FIGS. 1 to 4.

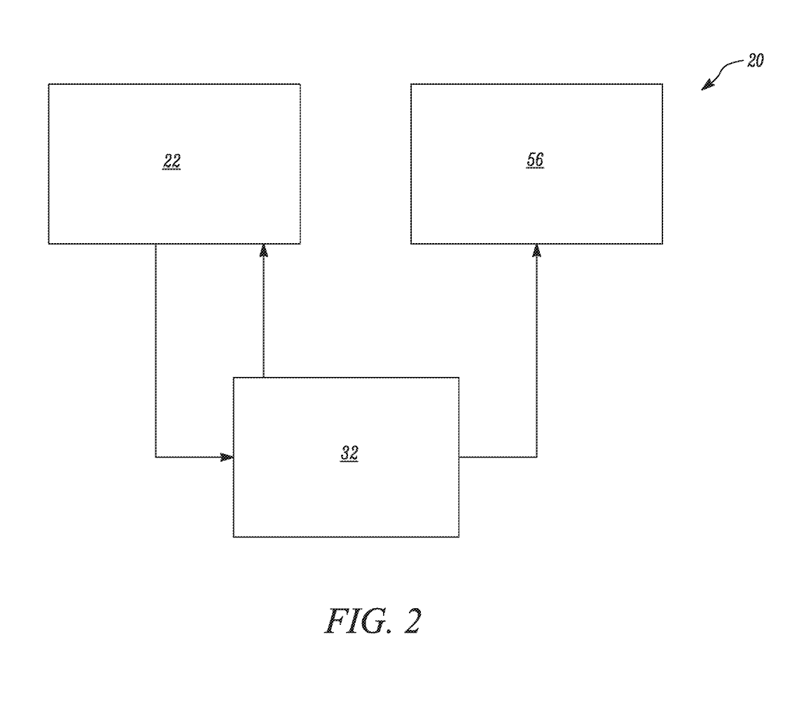

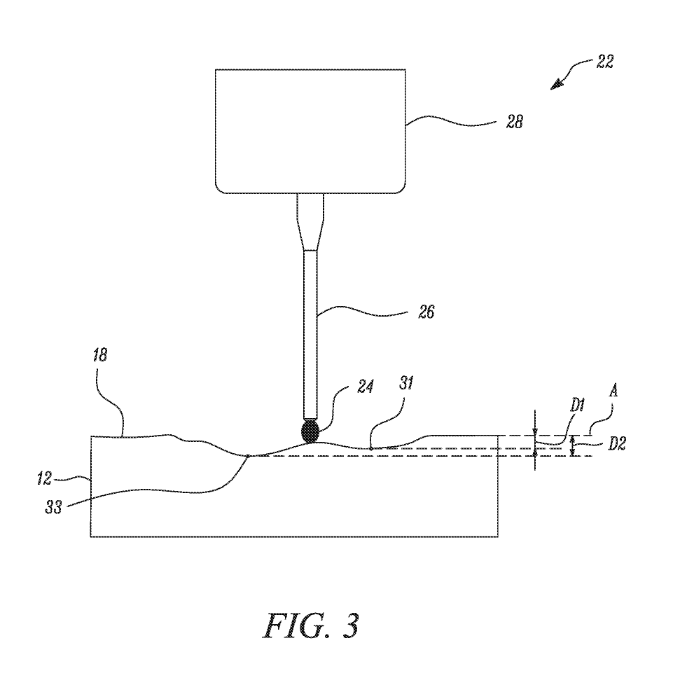

Referring to FIGS. 1 and 2, the system 20 includes a surface evaluating device 22. In the illustrated example, the surface evaluating device 22 is a scanning probe sold under the brand Sprint™ available from Renishaw®. Alternatively, any other surface evaluating device 22 that performs the intended function may be used, without any limitations. The surface evaluating device 22 is associated with the CNC machine 11. The surface evaluating device 22 is positioned and relatively moved across the surface 18 of the machine component 12. The surface evaluating device 22 defines a reference plane “A” by touching the surface 18 at four random points. Referring to FIG. 3, the surface evaluating device 22 includes a ruby ball 24, a stylus 26, and a head 28. The ruby ball 24 is operatively coupled to the stylus 26, that is in turn coupled to the head 28.

The surface evaluating device 22 generates a set of data points defined on the surface 18 of the machine component 12. The set of data points correspond to various locations that are defined on the surface 18 of the machine component 12. More particularly, the ruby ball 24 of the surface evaluating device 22 slides on the surface 18 of the machine component 12 to generate the set of data points. The set of data points are indicative of dimensional characteristics of the surface 18 of the machine component 12. For example, the surface evaluating device 22 generates a first data point corresponding to a first location 31 defined on the surface 18. Further, the surface evaluating device 22 generates a second data point corresponding to a second location 33 defined on the surface 18. It should be noted that the set of data points are generated at various locations on the surface 18.

Referring to FIG. 2, the system 20 includes a control module 32. The control module 32 is in communication with the surface evaluating device 22, and receives signals therefrom. The control module 32 may embody a CPU, a microprocessor, a PLC or similar other devices. The control module 32 may include one or more input and output modules for receiving and transferring data. The control module 32 receives manual inputs from a user interface (not shown). Further, the control module 32 may include an associated memory or a database that may store the information processed by the control module 32 or any information received from other sources (not shown), without limiting the scope of the disclosure.

The control module 32 controls and operates the surface evaluating device 22. Further, the control module 32 also receives and processes information generated by the surface evaluating device 22. More particularly, the control module 32 receives the set of data points from the surface evaluating device 22. Further, the control module 32 determines a first depth of wear “D1” at the first location 31 on the surface 18 of the machine component 12 relative to the reference plane “A”. Also, a second depth of wear “D2” at the second location 33 on the surface 18 of the machine component 12 relative to the reference plane “A”. It should be noted that the control module 32 generates the depth of wear at various locations on the surface 18.

Further, the control module 32 determines a maximum depth of wear “Dm” of the surface 18 based on the set of data points. For example, the control module 32 compares the first depth of wear “D1” at the first location 31 and the second depth of wear “D2” at the second location 33. If the second depth of wear “D2” at the second location 33 is greater than the first depth of wear “D1” at the first location 31, then the second depth of wear “D2” is considered as the maximum depth of wear “Dm”. The control module 32 compares the depth of wear of all the set of data points generated at various locations on the surface 18, and determines the maximum depth of wear “Dm” from the set of data points.

The control module 32 compares the maximum depth of wear “Dm” to a reference value “R”. The reference value “R” is stored in the memory or the database associated with the control module 32. In one example, the reference value “R” is a tolerance limit allowed for the surface 18 of the machine component 12, according to part specifications of the machine component 12. Alternatively, the reference value “R” may be entered manually using the user interface. The control module 32 determines an amount of material to be removed, based on the maximum depth of wear “Dm”. The amount of material to be removed is a value determined by historical data and analysis of the machine component 12 in various wear and machining conditions. It should be noted that the amount of material removed may be greater than the maximum depth of wear “Dm”.

The control module 32 communicates the amount of material to he removed to a machining unit 56 of the CNC machine 11. The machining unit 56 may include a milling tool, a cutting tool, a boring tool, a grinding tool, etc. based on system requirements. The machining unit 56 is in communication with the control module 32. Based on the communication, a machining operation such as milling, cutting etc., is performed by the machining unit 56 of the CNC machine 11 on the surface 18.

### Industrial Applicability

The present disclosure has applicability in inspection, remanufacture, or repair of the machine component 12 having the surface 18 which is subjected to surface imperfections due to various stresses and loads. Moreover, such tasks may be accomplished using the system 20 described herein. The present disclosure also enables determination of the wear of the surface 18 of the machine component 12.

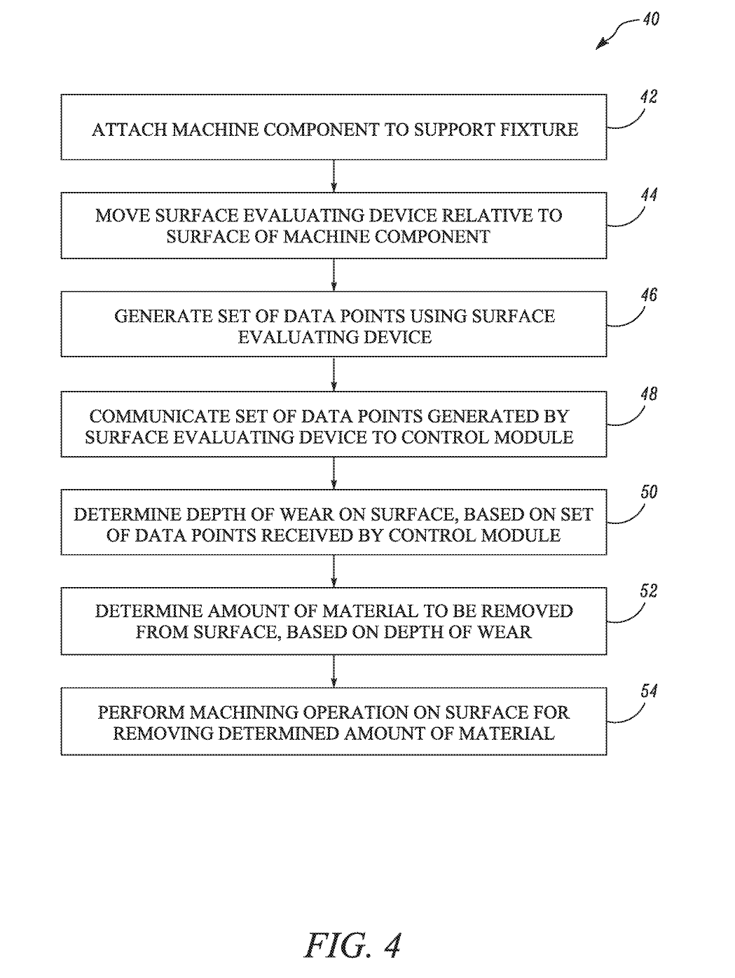

The present disclosure relates to a method 40 for remanufacturing the surface 18 of the machine component 12. FIG. 4 is a flow chat for a method 40 of remanufacturing the surface 18 of the machine component 12. At step 42, the machine component 12 is attached to the support fixture 10 of the CNC machine 11. At step 44, the surface evaluating device 22 is moved relative to the surface 18 of the machine component 12. At step 46, the set of data points are generated using the surface evaluating device 22. The set of data points are indicative of the dimensional characteristics of the surface 18 of the machine component 12.

At step 48, the generated set of data points are communicated by the surface evaluating device 22 to the control module 32. At step 50, the depth of wear on the surface 18 is determined, based on the set of data points received by the control module 32. At step 52, the amount of material to be removed from the surface 18 is determined, based on the depth of wear. At step 54, the machining operation on the surface 18 is performed in order to remove the determined amount of material.

The method 40 enables remanufacturing the surface 18 by implementing steps of the method 40. With such an implementation, an extent of the wear of the surface 18 may also be determined. It may also be contemplated that the system 20 and the method 40 may be used during manufacturing of any machine component for accurately detecting any manufacturing defect.

Moreover, the amount of material to be removed from the surface 18 may be also be determined based on the maximum depth of wear “Dm”. Therefore, multiple cycle times associated with repetitive inspection and machining may be minimized. For example, measuring an overall height of the surface 18 repeatedly, after each machining step, to determine if the height of the surface 18 is within the part specifications of the machine component 12 may be avoided.

The system 20 and the method 40 disclosed above, increases service life of the machine component 12 by removing optimal amount of material. Also, the present disclosure provides a cost effective system and method for remanufacturing the machine component 12.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of remanufacturing a surface of a machine component, the method comprising:
attaching the machine component to a support fixture;
moving a surface evaluating device relative to the surface of the machine component;
generating a set of data points using the surface evaluating device, wherein the set of data points are indicative of dimensional characteristics of the surface of the machine component;
communicating the set of data points generated by the surface evaluating device to a control module;
determining a depth of wear on the surface, based on the set of data points received by the control module,
determining an amount of material to be removed from the surface, based on the depth of wear; and
performing a machining operation on the surface for removing the determined amount of material.
